(19) United States
(12) Patent Application Publication
(10) Pub. No.: US 2025/0061886 A1
(43) Pub. Date: Feb. 20, 2025

(54) METHOD AND APPARATUS FOR TRAINING SPEECH SYNTHESIS MODEL, DEVICE, STORAGE MEDIUM AND PROGRAM PRODUCT

(71) Applicant: Tencent Technology (Shenzhen) Company Limited, Shenzhen (CN)

(72) Inventors: Shan YANG, Shenzhen (CN); Dan SU, Shenzhen (CN)

(73) Assignee: Tencent Technology (Shenzhen) Company Limited, Shenzhen (CN)

(21) Appl. No.: 18/937,908

(22) Filed: Nov. 5, 2024

Related U.S. Application Data
(63) Continuation of application No. PCT/CN2023/121737, filed on Sep. 26, 2023.

(30) Foreign Application Priority Data
Nov. 4, 2022 (CN) 202211376239.X

(51) Int. Cl. G10L 13/04; G10L 19/16

(52) U.S. Cl. CPC G10L 13/04; G10L 19/167

(57) ABSTRACT

This application provides a method for training a speech synthesis model, a speech synthesis method, an apparatus, an electronic device, a computer-readable storage medium, and a computer program product. The method for training a speech synthesis model includes: obtaining a text sample and a standard speech corresponding to the text sample; performing speech bit stream prediction on the text sample by using the speech synthesis model, to obtain a speech bit stream corresponding to the text sample; decoding the speech bit stream by using the speech synthesis model, to obtain a synthesized speech corresponding to the text sample; and updating a model parameter of the speech synthesis model based on a difference between the synthesized speech and the standard speech.

### RELATED APPLICATION

This application is a continuation of International Patent Application No. PCT/CN2023/121737, filed Sep. 26, 2023, which claims priority to Chinese Patent Application No. 202211376239.X filed on Nov. 4, 2022. The contents of International Patent Application No. PCT/CN2023/121737 and Chinese Patent Application No. 202211376239.X are each incorporated herein by reference in their entirety.

### FIELD OF THE TECHNOLOGY

This application relates to the field of artificial intelligence technologies, and in particular, to a method for training a speech synthesis model, a speech synthesis method, an apparatus, an electronic device, a computer-readable storage medium, and a computer program product.

### BACKGROUND OF THE DISCLOSURE

Speech synthesis is a technology in which text is synthesized into a speech by using a speech synthesis model. In the related art, the speech synthesis model includes two parts: an acoustic model and a vocoder. The acoustic model models a Mel spectrum feature of the speech from the text, and the vocoder restores a speech signal from a Mel spectrum. However, because the Mel spectrum feature modeled by the acoustic model is lossy (with a large error) and irreversible, a vocoder with a complex parameter is generally required to restore the speech signal from the Mel spectrum predicted by the acoustic model. As a result, complexity of the speech synthesis model is excessively high, the speech synthesis model needs to be trained for a long time, and efficiency of training the speech synthesis model is low.

### SUMMARY

Embodiments of this application provide a method for training a speech synthesis model, a speech synthesis method, an apparatus, an electronic device, a computer-readable storage medium, and a computer program product, which can improve efficiency of training a speech synthesis model.

Technical solutions of the embodiments of this application are implemented as follows:

An embodiment of this application provides a method for training a speech synthesis model, the method including:
obtaining a text sample and a standard speech corresponding to the text sample;
performing speech bit stream prediction on the text sample by using the speech synthesis model, to obtain a speech bit stream corresponding to the text sample;
decoding the speech bit stream by using the speech synthesis model, to obtain a synthesized speech corresponding to the text sample; and
updating a model parameter of the speech synthesis model based on a difference between the synthesized speech and the standard speech, the speech synthesis model being configured to output, based on inputted target text, a synthesized speech of the target text.

An embodiment of this application provides a method for training a speech synthesis model, the speech synthesis model including: a speech decoding model and an acoustic model; and the method including:
obtaining a text sample and a standard speech corresponding to the text sample;
encoding the standard speech, to obtain a standard speech bit stream;
decoding the standard speech bit stream by using the speech decoding model, to obtain a decoded speech, and training the speech decoding model based on a difference between the standard speech and the decoded speech; and
performing speech bit stream prediction on the text sample by using the acoustic model, to obtain a speech bit stream, and training the acoustic model based on a difference between the standard speech bit stream and the speech bit stream,
the speech synthesis model being configured to perform speech bit stream prediction on target text based on the acoustic model to obtain a target speech bit stream, and decode the target speech bit stream based on the speech decoding model to obtain a synthesized speech of the target text.

An embodiment of this application provides a speech synthesis method, applied to a speech synthesis model, the method including:
obtaining to-be-synthesized text for speech synthesis;
performing speech bit stream prediction on the to-be-synthesized text by using the speech synthesis model, to obtain a target speech bit stream; and
decoding the target speech bit stream by using the speech synthesis model, to obtain a target synthesized speech of the to-be-synthesized text,
the speech synthesis model being obtained through training based on the method for training a speech synthesis model provided in the embodiments of this application.

An embodiment of this application further provides an apparatus for training a speech synthesis model, including:
a first obtaining module, configured to obtain a text sample and a standard speech corresponding to the text sample;
a prediction module, configured to perform speech bit stream prediction on the text sample by using the speech synthesis model, to obtain a speech bit stream corresponding to the text sample;
a decoding module, configured to decode the speech bit stream by using the speech synthesis model, to obtain a synthesized speech corresponding to the text sample; and
an update module, configured to update a model parameter of the speech synthesis model based on a difference between the synthesized speech and the standard speech,
the speech synthesis model being configured to output, based on inputted target text, a synthesized speech of the target text.

An embodiment of this application further provides an apparatus for training a speech synthesis model, the speech synthesis model including: a speech decoding model and an acoustic model; and the apparatus including:
a second obtaining module, configured to obtain a text sample and a standard speech corresponding to the text sample;
an encoding module, configured to encode the standard speech, to obtain a standard speech bit stream;
a first training module, configured to decode the standard speech bit stream by using the speech decoding model to obtain a decoded speech, and train the speech decoding model based on a difference between the standard speech and the decoded speech; and
a second training module, configured to perform speech bit stream prediction on the text sample by using the acoustic model to obtain a speech bit stream, and train the acoustic model based on a difference between the standard speech bit stream and the speech bit stream,
the speech synthesis model being configured to perform speech bit stream prediction on target text based on the acoustic model to obtain a target speech bit stream, and decode the target speech bit stream based on the speech decoding model to obtain a synthesized speech of the target text.

An embodiment of this application provides a speech synthesis apparatus, applied to a speech synthesis model, the speech synthesis model including: a speech decoding model and an acoustic model, the apparatus including:
a third obtaining module, configured to obtain to-be-synthesized text for speech synthesis;
a bit stream prediction module, configured to perform speech bit stream prediction on the to-be-synthesized text by using the speech synthesis model, to obtain a target speech bit stream; and
a bit stream decoding module, configured to decode the target speech bit stream by using the speech synthesis model, to obtain a target synthesized speech of the to-be-synthesized text,
the speech synthesis model being obtained through training based on the method for training a speech synthesis model provided in the embodiments of this application.

An embodiment of this application further provides an electronic device, including:
a memory, configured to store computer-executable instructions; and
a processor, configured to implement, when executing the computer-executable instructions stored in the memory, the method provided in the embodiments of this application.

An embodiment of this application further provides a computer-readable storage medium, having computer-executable instructions stored therein, the computer-executable instructions, when executed by a processor, implementing the method provided in the embodiments of this application.

An embodiment of this application further provides a computer program product, including a computer program or computer-executable instructions, the computer program or the computer-executable instructions, when executed by a processor, implementing the method provided in the embodiments of this application.

The embodiments of this application have the following beneficial effects:

When the embodiments of this application are applied, to train the speech synthesis model, speech bit stream prediction is performed on the text sample by using the speech synthesis model, to obtain the speech bit stream. Then, the speech bit stream is decoded by using the speech synthesis model to obtain the synthesized speech of the text sample, and then the model parameter of the speech synthesis model is updated based on the difference between the synthesized speech and the standard speech of the text sample, to train the speech synthesis model. In this way, in the embodiments of this application, for a bit stream decoding process in which the speech bit stream of the text sample is decoded to obtain the synthesized speech of the text sample, calculation complexity is low compared with the related art in which a vocoder restores a synthesized speech from a Mel spectrum to perform model training. This, in turn, reduces complexity of data calculation and consumption of device resources in a process of training the speech synthesis model. In this way, duration for training the speech synthesis model can be reduced, and efficiency of training the speech synthesis model and a utilization rate of the device resource can be improved.

### BRIEF DESCRIPTION OF THE DRAWINGS

FIG. 1 is a schematic architectural diagram of a system for training a speech synthesis model according to an embodiment of this application.

FIG. 2 is a schematic structural diagram of an electronic device performing a method for training a speech synthesis model according to an embodiment of this application.

FIG. 3 is a schematic flowchart of a method for training a speech synthesis model according to an embodiment of this application.

FIG. 4 is a schematic structural diagram of a speech synthesis model according to an embodiment of this application.

FIG. 5 is a schematic diagram of training of a speech encoding model and an initial speech decoding model according to an embodiment of this application.

FIG. 6 is a schematic flowchart of a method for training a speech synthesis model according to an embodiment of this application.

FIG. 7 is a schematic flowchart of a speech synthesis method according to an embodiment of this application.

FIG. 8 is a schematic flowchart of a speech synthesis method according to an embodiment of this application.

FIG. 9 is a schematic diagram of comparison between a speech synthesis method according to the related art and a speech synthesis method according to an embodiment of this application.

### DESCRIPTION OF EMBODIMENTS

To make the objectives, technical solutions, and advantages of this application clearer, the following describes this application in detail with reference to the accompanying drawings. The described embodiments are not to be considered as a limitation to this application. All other embodiments obtained by a person of ordinary skill in the art without creative efforts shall fall within the protection scope of this application.

In the following descriptions, related “some embodiments” describe a subset of all possible embodiments. However, the “some embodiments” may be the same subset or different subsets of all the possible embodiments, and may be combined with each other without conflict.

In the following descriptions, the included term “first/second/third” is merely intended to distinguish similar objects but does not necessarily indicate specific order of an object. “First/second/third” is interchangeable in terms of a specific order or sequence if permitted, so that the embodiments of this application described herein can be implemented in a sequence in addition to the sequence shown or described herein.

Unless otherwise defined, meanings of all technical and scientific terms used in this specification are the same as those usually understood by a person skilled in the art to which this application belongs. Terms used in this specification are merely intended to describe objectives of the embodiments of this application, but are not intended to limit this application.

Before the embodiments of this application are described in detail, nouns and terms involved in the embodiments of this application are described. The nouns and terms involved in the embodiments of this application are applicable to the following explanations.

(1) The term “in response to” is used herein for representing a condition or status on which a to-be-performed operation depends. When the condition or status is satisfied, one or more operations may be performed in real time or after a set delay. Unless explicitly stated, there is no limitation on an order in which the plurality of operations are performed.

(2) The term “speech synthesis” is used is also referred to as a text to speech (TTS) technology, and is a technology in which an artificial speech is generated through mechanical and electronic methods. The TTS technology is a technology in which text information generated by a computer or inputted externally is converted into an audible and fluent Chinese spoken language for output.

(3) The term “encoding” is a process of converting information from one form or format into another form, and is also referred to as code of a computer programming language, referred to as encoding for short. Characters, numbers, or other objects are encoded into digits by using a predetermined method, or information and data are converted into a specified electrical pulse signal. Decoding is a reverse process of encoding.

(4) The term “decoding” is a process of using a particular method to restore numerical code to content represented by the code, or convert an electrical pulse signal, an optical signal, a radio wave, or the like to information, data, or the like represented by the electrical pulse signal, the optical signal, the radio wave, or the like. Decoding is a process in which a recipient restores a received symbol or code into information, and corresponds to an encoding process.

(5) The term “acoustic model” herein is configured to model an acoustic feature representation of a speech from text.

(6) The term “quantization” is a process of approximating continuous values (or a large quantity of possible discrete values) of a signal to a finite plurality (or a small quantity) of discrete values.

Based on the foregoing explanations of the nouns and the terms, the following describes in detail a method for training a speech synthesis model, a speech synthesis method, an apparatus, an electronic device, a computer-readable storage medium, and a computer program product provided in the embodiments of this application. The method for training a speech synthesis model provided in the embodiments of this application can improve efficiency of training the speech synthesis model.

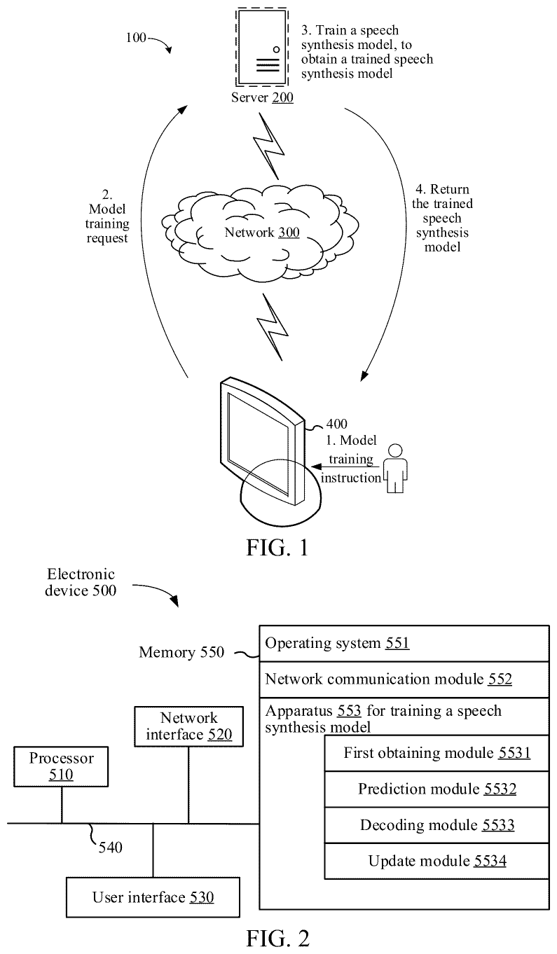

The following describes an implementation scenario of the method for training a speech synthesis model provided in the embodiments of this application. FIG. 1 is a schematic architectural diagram of a system 100 for training a speech synthesis model according to an embodiment of this application. To support an exemplary application, a terminal 400 is connected to a server 200 by using a network 300. The network 300 may be a wide area network, a local area network, or a combination of the two, and implements data transmission by using a wireless or wired link.

The terminal 400 is configured to transmit a model training request for the speech synthesis model to the server 200 in response to a model training instruction for the speech synthesis model. The server 200 is configured to: receive the model training request transmitted by the terminal 400; obtain a text sample and a standard speech corresponding to the text sample in response to the model training request; perform speech bit stream prediction on the text sample by using the speech synthesis model, to obtain a speech bit stream corresponding to the text sample; decode the speech bit stream by using the speech synthesis model, to obtain a synthesized speech corresponding to the text sample; and update a model parameter of the speech synthesis model based on a difference between the synthesized speech and the standard speech, to train the speech synthesis model. In this way, a trained speech synthesis model is obtained. In some embodiments, after obtaining the trained speech synthesis model, the server may actively transmit the trained speech synthesis model to the terminal 400. Certainly, the server may alternatively transmit the trained speech synthesis model when the terminal 400 obtains the speech synthesis model.

In some embodiments, when speech synthesis is performed based on text, a speech synthesis instruction may be triggered at the terminal 400. The terminal 400 obtains, in response to the speech synthesis instruction, a speech synthesis model for speech synthesis, and obtains to-be-synthesized text for speech synthesis; performs speech bit stream prediction on the to-be-synthesized text by using the speech synthesis model, to obtain a target speech bit stream; and decodes the target speech bit stream by using the speech synthesis model, to obtain a target synthesized speech of the to-be-synthesized text. In this way, the target synthesized speech synthesized based on the to-be-synthesized text is outputted.

In some embodiments, the method for training a speech synthesis model provided in the embodiments of this application may be performed by various electronic devices, for example, may be performed by a terminal alone, or may be performed by a server alone, or may be performed by a terminal and a server in cooperation. For example, a terminal alone performs the method for training a speech synthesis model provided in the embodiments of this application, or the terminal transmits a model training request for a speech synthesis model to a server, and the server performs, based on the received model training request, the method for training a speech synthesis model provided in the embodiments of this application. The embodiments of this application may be applied to various scenarios, including, but not limited to, a cloud technology, artificial intelligence, smart transportation, assisted driving, and the like.

In some embodiments, the electronic device implementing training of the speech synthesis model provided in the embodiments of this application may be any type of a terminal device or a server. The server (for example, the server 200) may be an independent physical server, or may be a server cluster or a distributed system including a plurality of physical servers. The terminal (for example, the terminal 400) may be a smartphone, a tablet computer, a notebook computer, a desktop computer, an intelligent speech interaction device (for example, a smart speaker), a smart home appliance (for example, a smart television), a smartwatch, an in-vehicle terminal, or the like, but is not limited thereto. The terminal device and the server may be directly or indirectly connected in a wired or wireless communication manner. This is not limited in the embodiments of this application.

In some embodiments, the method for training a speech synthesis model provided in the embodiments of this application may be implemented with the help of a cloud technology. The cloud technology is a hosting technology that unifies a series of resources such as hardware, software, and networks in a wide area network or a local area network to implement computing, storage, processing, and sharing of data. The cloud technology is a collective name of a network technology, an information technology, an integration technology, a management platform technology, an application technology, and the like based on an application of a cloud computing business mode, and may form a resource pool, which is used as required, and is flexible and convenient. A cloud computing technology becomes an important support. A background service of a technical network system requires a large amount of computing and storage resources. In an example, the server (for example, the server 200) may alternatively be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data or an artificial intelligence platform.

In some embodiments, the terminal or the server may implement, by running a computer program, the method for training a speech synthesis model provided in the embodiments of this application. For example, the computer program may be a native program or a software module in an operating system; may be a native application (APP), namely, a program that needs to be installed in an operating system to run; or may be an applet, namely, a program that only needs to be downloaded into a browser environment to run; or may be an applet that can be embedded into any APP. In conclusion, the foregoing computer program may be any form of an application, a module, or a plug-in.

In some embodiments, a plurality of servers may form a blockchain, and the server is a node on the blockchain. There may be information connections among nodes in the blockchain, and the nodes may transmit information through the foregoing information connections. Data (for example, a speech synthesis model, an initial speech decoding model, an initial acoustic model, a first determining model, and a second determining model) related to the method for training a speech synthesis model provided in the embodiments of this application may be stored on the blockchain.

The electronic device performing the method for training a speech synthesis model provided in the embodiments of this application is described below. FIG. 2 is a schematic structural diagram of an electronic device 500 performing a method for training a speech synthesis model according to an embodiment of this application. An example in which the electronic device 500 is the server shown in FIG. 1 is used. The electronic device 500 performing the method for training a speech synthesis model according to this embodiment of this application includes: at least one processor 510, a memory 550, at least one network interface 520, and a user interface 530. All components in the electronic device 500 are coupled together by using a bus system 540. The bus system 540 is configured to implement connection and communication between the components. In addition to a data bus, the bus system 540 further includes a power bus, a control bus, and a state signal bus. However, for clear description, all types of buses in FIG. 2 are marked as the bus system 540.

The processor 510 may be an integrated circuit chip having a signal processing capability, for example, a general purpose processor, a digital signal processor (DSP), or another programmable logic device, discrete gate, transistor logical device, or discrete hardware component. The general purpose processor may be a microprocessor, any conventional processor, or the like.

The memory 550 may be a removable memory, a non-removable memory, or a combination thereof. In some embodiments, the memory 550 includes one or more storage devices physically away from the processor 510. The memory 550 includes a volatile memory or a non-volatile memory, or may include both a volatile memory and a non-volatile memory. The non-volatile memory may be a read-only memory (ROM). The volatile memory may be a random access memory (RAM). The memory 550 described in this embodiment of this application is to include any other suitable type of memories.

In some embodiments, the memory 550 can store data to support various operations. Examples of the data include a program, a module, and a data structure, or a subset or a superset thereof, which are described below by using examples.

An operating system 551 includes a system program configured to process various basic system services and perform a hardware-related task, such as a framework layer, a core library layer, or a driver layer, and is configured to implement various basic services and process a hardware-based task.

A network communication module 552 is configured to reach another electronic device through one or more (wired or wireless) network interfaces 520. Exemplary network interfaces 520 include: Bluetooth, wireless compatible authentication (Wi-Fi), a universal serial bus (USB), and the like.

In some embodiments, an apparatus for training a speech synthesis model provided in the embodiments of this application may be implemented by using software. FIG. 2 shows an apparatus 553 for training a speech synthesis model stored in the memory 550. The apparatus may be software in a form such as a program or a plug-in, and includes the following software modules: a first obtaining module 5531, a prediction module 5532, a decoding module 5533, and an update module 5534. These modules are logical modules, and therefore may be randomly combined or divided based on a function to be performed. The following describes a function of each module.

The following describes the method for training a speech synthesis model provided in the embodiments of this application. The speech synthesis model includes: a speech decoding model and an acoustic model. In some embodiments, the method for training a speech synthesis model provided in the embodiments of this application may be performed by various electronic devices, for example, may be performed by a terminal alone, may be performed by a server alone, or may be collaboratively performed by a terminal and a server.

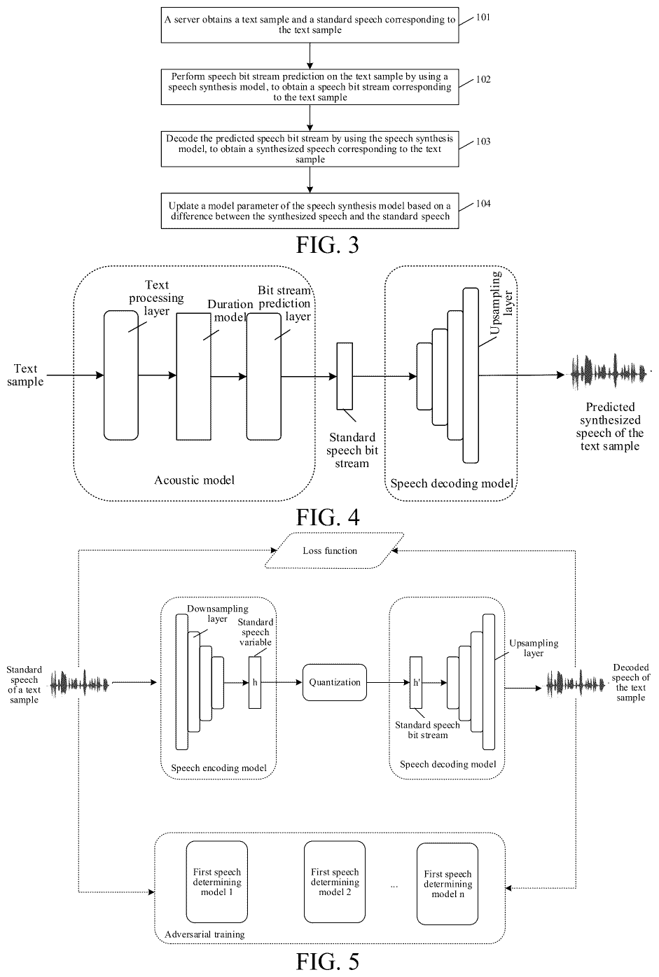

An example in which the method is performed by a server is used. FIG. 3 is a schematic flowchart of a method for training a speech synthesis model according to an embodiment of this application. The method for training a speech synthesis model according to this embodiment of this application includes the following operations.

Operation 101: A server obtains a text sample and a standard speech corresponding to the text sample.

In actual application, a user may trigger a model training instruction for the speech synthesis model at a terminal, thereby causing the terminal to transmit a model training request for the speech synthesis model to the server. If receiving the model training request transmitted by the terminal, the server trains the speech synthesis model in response to the model training request. In operation 101, when training the speech synthesis model, the server first obtains a text sample for training and a standard speech corresponding to the text sample. The standard speech is obtained by reading the text sample. For example, the text sample may include “hello”, “it is nice to meet you”, or the like.

In some embodiments, the text sample and the standard speech corresponding to the text sample may be provided by the terminal. For example, when the terminal transmits the model training request, the model training request carries the text sample and the standard speech corresponding to the text sample. In actual application, a training client of the speech synthesis model may be arranged on the terminal. The user may trigger the model training instruction for the speech synthesis model based on a model training interface of the training client, and upload, based on a sample submission interface of the training client, a training sample, namely, the text sample and the standard speech corresponding to the text sample, for training the speech synthesis model. In this way, after the terminal transmits a plurality of training samples uploaded by the user to the server, the server can obtain the text sample and the standard speech corresponding to the text sample.

In some embodiments, the standard speech may correspond to a target object. In other words, the standard speech may be a standard speech obtained by the target object reading the text sample. Then, the speech synthesis model obtained through training based on the standard speech of the target object may synthesize a synthesized speech of the target object based on text. For example, a timbre of the synthesized speech is the same as that of the target object.

Operation 102: Perform speech bit stream prediction on the text sample by using the speech synthesis model, to obtain a speech bit stream corresponding to the text sample.

In this embodiment of this application, the speech synthesis model is configured to output, for inputted text, a speech corresponding to the text. To be specific, the speech synthesis model performs speech synthesis based on the text, to obtain the speech corresponding to the text. The speech synthesis model may include a speech decoding model and an acoustic model. In operation 102, after obtaining the text sample and the standard speech corresponding to the text sample, the server performs speech bit stream prediction on the text sample by using the acoustic model of the speech synthesis model, to obtain the speech bit stream (namely, an audio bit stream) corresponding to the text sample.

The audio bit stream may be obtained by encoding and compressing audio, and the corresponding audio may be obtained by decoding the audio bit stream. Therefore, in actual application, after speech bit stream (namely, the audio bit stream) prediction is performed based on the text sample by invoking the acoustic model, a corresponding speech may be obtained by decoding the speech bit stream obtained through prediction.

Exemplarily, FIG. 4 is a schematic structural diagram of a speech synthesis model according to an embodiment of this application. An acoustic model may also be based on a neural network architecture. The acoustic model may include a text processing layer (for example, a text encoder), a duration model, and a bit stream prediction layer (for example, an autoregressive decoder). The text processing layer is configured to process a text sample, for example, perform text regularization, word segmentation, feature extraction, or phoneme conversion on the text sample. The duration model is configured to predict pronunciation duration of a phoneme of each piece of text in the text sample. The bit stream prediction layer is configured to perform speech bit stream prediction based on the pronunciation duration of the phoneme of each piece of text. The speech decoding model may be a decoder constructed based on a neural network (for example, a convolutional neural network or a deep neural network). The speech decoding model may include a plurality of cascaded upsampling layers, so that a speech bit stream outputted by the acoustic model is decoded by using the plurality of cascaded upsampling layers, to obtain a synthesized speech corresponding to the text sample.

In some embodiments, a server may perform speech bit stream prediction on the text sample, to obtain a speech bit stream corresponding to the text sample in the following manner: performing word segmentation on the text sample to obtain a plurality of word segments, and performing feature extraction on each word segment to obtain a word segment feature of each word segment; obtaining a phoneme (namely, a pronunciation unit forming a pronunciation of a word) of each piece of text in the text sample, and performing pronunciation duration prediction on each phoneme, to obtain pronunciation duration of each phoneme; performing, for each word segment, speech bit stream prediction on the word segment based on pronunciation duration of a phoneme of text included in the word segment and the word segment feature of the word segment, to obtain a word segment bit stream of the word segment; and splicing word segment bit streams of the plurality of word segments, to obtain the speech bit stream corresponding to the text sample.

Still referring to FIG. 4, in actual application: (1) First, regularization is performed on the text sample by using the text processing layer of the acoustic model to obtain a standard text sample, then word segmentation is performed on the standard text sample to obtain a plurality of word segments, and then feature extraction is performed on each word segment to obtain a word segment feature of each word segment. In some embodiments, phoneme conversion may be further performed on each piece of text in the standard text sample by using the text processing layer of the acoustic model, to obtain a phoneme of each piece of text in the text sample. (2) Pronunciation duration prediction is performed on each phoneme by using the duration model of the acoustic model, to obtain pronunciation duration of each phoneme. (3) For each segment, speech bit stream prediction is performed on the word segment by using the bit stream prediction layer of the acoustic model based on pronunciation duration of a phoneme of text included in the word segment and the word segment feature of the word segment, to obtain a word segment bit stream of the word segment, so that word segment bit streams of the plurality of word segments are spliced, to obtain the speech bit stream corresponding to the text sample.

In some embodiments, before performing speech bit stream prediction on the text sample by using the acoustic model of the speech synthesis model, to obtain the speech bit stream corresponding to the text sample, the server may train an initial acoustic model to obtain the acoustic model in the following manner: encoding the standard speech, to obtain a standard speech bit stream; performing speech bit stream prediction on the text sample by using the initial acoustic model, to obtain a target speech bit stream; updating a model parameter of the initial acoustic model based on a difference between the standard speech bit stream and the target speech bit stream, to train the initial acoustic model; and determining a trained initial acoustic model as the acoustic model.

In this embodiment, the acoustic model may be obtained by pre-training the initial acoustic model. In actual application, the standard speech of the text sample may be encoded, to obtain the standard speech bit stream; then speech bit stream prediction is performed on the text sample by using the initial acoustic model, to obtain the target speech bit stream; and the model parameter of the initial acoustic model is updated based on the difference between the standard speech bit stream and the target speech bit stream, to train the initial acoustic model. To be specific, during training, the difference between the standard speech bit stream and the target speech bit stream is made smaller, to cause the initial acoustic model to learn from the text sample to generate the standard speech bit stream, thereby enabling the initial acoustic model to implement a process of text input and speech bit stream output. For example, a value of a loss function of the initial acoustic model may be determined based on the difference between the standard speech bit stream and the target speech bit stream, so that the model parameter of the initial acoustic model is updated based on the value of the loss function, to train the initial acoustic model, so that the trained initial acoustic model is determined as the acoustic model.

In actual application, the loss function of the initial acoustic model may be [symbol] =|h′−m(t)|,
where h′ is the standard speech bit stream, a function m represents a calculation procedure of the acoustic model, t represents an inputted text sample, and m(t) is a speech bit stream obtained through prediction by using the initial acoustic model.

In some other embodiments, a training sample of the initial acoustic model may alternatively be a first text sample different from the foregoing text sample, so that the initial acoustic model is trained based on the first text sample and a first standard speech of the first text sample. For example, the first standard speech of the first text sample is encoded, to obtain a first standard speech bit stream; speech bit stream prediction is performed on the first text sample by using the initial acoustic model, to obtain a first speech bit stream; the model parameter of the initial acoustic model is updated based on a difference between the first standard speech bit stream and the first speech bit stream, to train the initial acoustic model; and a trained initial acoustic model is determined as the acoustic model.

In some embodiments, the standard speech includes a plurality of sampling points. The server may encode the standard speech to obtain the standard speech bit stream in the following manner: performing downsampling on each sampling point by using a plurality of cascaded downsampling layers, to obtain a standard speech variable of each sampling point; and quantizing the standard speech variable of each sampling point, to obtain the standard speech bit stream.

Sampling is a process of digitizing an analog signal. A higher sampling rate indicates a larger amount of data used in recording a same segment of audio signal and higher audio quality. In actual application, for an AAC frame, generally one frame is based on 1,024 sampling points, and playback time of an audio frame=a quantity of sampling samples corresponding to one AAC frame/the sampling rate (unit: s). For example, the sampling rate is 44,100 Hz, representing 44,100 sampling points per second.

Operation 103: Decode the speech bit stream by using the speech synthesis model, to obtain a synthesized speech corresponding to the text sample.

In operation 103, the server may decode the speech bit stream by using the speech decoding model of the speech synthesis model, to obtain the synthesized speech corresponding to the text sample. In some embodiments, still referring to FIG. 4, the speech decoding model includes a plurality of cascaded upsampling layers. The server may decode the speech bit stream, to obtain the synthesized speech corresponding to the text sample in the following manner: performing upsampling on the speech bit stream by using the plurality of cascaded upsampling layers, to obtain the synthesized speech corresponding to the text sample.

In some embodiments, before decoding the speech bit stream by using the speech decoding model of the speech synthesis model, to obtain the synthesized speech corresponding to the text sample, the server may train an initial speech decoding model to obtain the speech decoding model in the following manner:
encoding the standard speech, to obtain a standard speech bit stream; decoding the standard speech bit stream by using the initial speech decoding model, to obtain a decoded speech; updating a model parameter of the initial speech decoding model based on a difference between the standard speech and the decoded speech, to train the initial speech decoding model; and determining a trained initial speech decoding model as the speech decoding model.

In actual application, a value of a loss function of the initial speech decoding model may be determined based on the difference between the standard speech and the decoded speech; a corresponding error signal is determined based on the loss function of the initial speech decoding model when the value of the loss function of the initial speech decoding model reaches a threshold; and the error signal is back-propagated in the initial speech decoding model, and a model parameter of each layer of the initial speech decoding model is updated during the propagation.

The back-propagation is described herein. Training sample data is inputted into an input layer of a neural network model, passes through a hidden layer, and finally reaches an output layer, and a result is outputted. This is a forward-propagation process of the neural network model. Because there is an error between an output result of the neural network model and an actual result, an error between the output result and an actual value is calculated, and the error is back-propagated from the output layer to the hidden layer until the error is propagated to the input layer. In a back-propagation process, a value of the model parameter is adjusted based on the error. The foregoing process is continuously iterated until convergence is achieved.

In this embodiment, the speech decoding model may be obtained by pre-training the initial speech decoding model. In actual application, the standard speech of the text sample may be encoded, to obtain the standard speech bit stream; then the standard speech bit stream is decoded by using the initial speech decoding model, to obtain the decoded speech; and the model parameter of the initial speech decoding model is updated based on the difference between the standard speech and the decoded speech, to train the initial speech decoding model. To be specific, during training, the difference between the standard speech and the decoded speech is made smaller, to improve a decoding effect of the initial speech decoding model, thereby training the initial speech decoding model. For example, the value of the loss function of the initial speech decoding model may be determined based on the difference between the standard speech and the decoded speech, so that the model parameter of the initial speech decoding model is updated based on the value of the loss function, to train the initial speech decoding model, so that the trained initial speech decoding model is determined as the speech decoding model.

In some embodiments, a training sample of the initial speech decoding model may alternatively be a second text sample different from the foregoing text sample, so that the initial speech decoding model is trained based on the second text sample and a second standard speech of the second text sample. For example, the second standard speech of the second text sample is encoded, to obtain a second standard speech bit stream; the second standard speech bit stream is decoded by using the initial speech decoding model, to obtain a second decoded speech; the model parameter of the initial speech decoding model is updated based on a difference between the second standard speech and the second decoded speech, to train the initial speech decoding model; and a trained initial speech decoding model is determined as the speech decoding model.

In some embodiments, after the standard speech bit stream is decoded by using the initial speech decoding model, to obtain the decoded speech, the server may further determine the decoded speech by using a first speech determining model, to obtain a first determining result, the first determining result being configured for indicating a degree of possibility that the decoded speech is obtained through decoding by using the initial speech decoding model. Correspondingly, the server may update the model parameter of the initial speech decoding model based on the difference between the standard speech and the decoded speech in the following manner: determining a value of a first loss function of the initial speech decoding model based on the difference between the standard speech and the decoded speech; determining a value of a second loss function of the initial speech decoding model based on the first determining result; and updating the model parameter of the initial speech decoding model based on the value of the first loss function and the value of the second loss function.

In this embodiment, the initial speech decoding model may also be trained by using an idea of adversarial training. To be specific, after the standard speech bit stream is decoded by using the initial speech decoding model to obtain the decoded speech, the decoded speech is determined by using the first speech determining model, to obtain the first determining result. The first speech determining model is configured to determine whether the decoded speech is generated by using the initial speech decoding model, in other words, determine a degree of possibility (or probability) that the decoded speech is generated by using the initial speech decoding model.

The standard speech may be considered as real speech data, and the decoded speech (generated by using the initial speech decoding model) may be considered as “counterfeit” speech data. When the first speech determining model is increasingly unable to determine whether the decoded speech is generated by using the initial speech decoding model (that is, the degree of possibility that the decoded speech is generated by using the initial speech decoding model is increasingly low), it is considered that the decoded speech is increasingly close to the standard speech. Therefore, the decoded speech may be determined by using the first speech determining model, to determine the degree of possibility (namely, the first determining result) that the decoded speech is generated by using the initial speech decoding model, to implement the adversarial training for the initial speech decoding model based on the first determining result. In actual application, when the first determining result indicates that the degree of possibility that the decoded speech is generated by using the initial speech decoding model is increasingly lower, it indicates that a decoding capability of the initial speech decoding model is increasingly better.

Based on this, when updating the model parameter of the initial speech decoding model based on the difference between the standard speech and the decoded speech, the server may determine the value of the first loss function of the initial speech decoding model based on the difference between the standard speech and the decoded speech, and determine the value of the second loss function of the initial speech decoding model based on the first determining result, to update the model parameter of the initial speech decoding model based on the value of the first loss function and the value of the second loss function.

In some embodiments, the standard speech includes a plurality of sampling points. The server may encode the standard speech to obtain the standard speech bit stream in the following manner: performing downsampling on each sampling point by using a plurality of cascaded downsampling layers, to obtain a standard speech variable of each sampling point; and quantizing the standard speech variable of each sampling point, to obtain the standard speech bit stream.

In some embodiments, the server may encode the standard speech to obtain the standard speech bit stream in the following manner: encoding the standard speech by using a speech encoding model, to obtain the standard speech bit stream. Correspondingly, the server may train the speech encoding model in the following manner: updating a model parameter of the speech encoding model based on the difference between the standard speech and the decoded speech, to train the speech encoding model.

In actual application, the foregoing process of encoding the standard speech may be implemented by using the speech encoding model. In this way, during training of the initial speech decoding model, the speech encoding model may also be jointly trained. To be specific, the standard speech is encoded by using the speech encoding model to obtain the standard speech bit stream, and the standard speech bit stream is decoded by using the initial speech decoding model to obtain the decoded speech; and the model parameter of the speech encoding model is updated based on the difference between the standard speech and the decoded speech. In actual application, a value of a loss function of the speech encoding model is determined based on the difference between the standard speech and the decoded speech, so that the model parameter of the speech encoding model is updated based on the value of the loss function, to train the speech encoding model.

In some other embodiments, a training sample of the speech encoding model may alternatively be a second text sample different from the foregoing text sample, so that the speech encoding model is trained based on the second text sample and a second standard speech of the second text sample. In actual application, the second standard speech is encoded by using the speech encoding model to obtain a second standard speech bit stream, and the second standard speech bit stream is decoded by using the initial speech decoding model to obtain a second decoded speech; and the model parameter of the speech encoding model is updated based on a difference between the second standard speech and the second decoded speech.

In actual application, text content of the second text sample may be different from text content of the foregoing text sample. Correspondingly, the second standard speech corresponding to the second text sample is also different from the standard speech corresponding to the foregoing text sample.

Exemplarily, FIG. 5 is a schematic diagram of training of a speech encoding model and an initial speech decoding model according to an embodiment of this application. A standard speech of a text sample is encoded by using the speech encoding model, to obtain a standard speech bit stream. The standard speech bit stream is decoded by using the initial speech decoding model, to obtain a decoded speech. The decoded speech is determined by using a first speech determining model, to obtain a first determining result, the first determining result being configured for indicating a degree of possibility that the decoded speech is obtained through decoding by using the initial speech decoding model. A value of a loss function of the speech encoding model and a value of a loss function of the initial speech decoding model are determined based on a difference between the standard speech and the decoded speech. A value of a determining loss function is determined based on the first determining result. A model parameter of the speech encoding model is updated based on the value of the loss function of the speech encoding model and the value of the determining loss function, to train the speech encoding model. A model parameter of the initial speech decoding model is updated based on the value of the loss function of the initial speech decoding model and the value of the determining loss function, to train the initial speech decoding model.

As shown in FIG. 5, the speech encoding model includes a plurality of cascaded downsampling layers. When encoding is performed on the standard speech, downsampling is performed on each sampling point in the standard speech by using the plurality of cascaded downsampling layers, to obtain a standard speech variable of each sampling point; and the standard speech variable of each sampling point is quantized, to obtain the standard speech bit stream.

Operation 104: Update a model parameter of the speech synthesis model based on a difference between the synthesized speech and the standard speech.

The speech synthesis model is configured to perform speech bit stream prediction on target text to obtain a target speech bit stream, and decode the target speech bit stream to obtain a synthesized speech of the target text.

After obtaining the synthesized speech, in operation 104, the server updates the model parameter of the speech synthesis model based on the difference between the synthesized speech and the standard speech, to train the speech synthesis model. In actual application, a value of a loss function of the speech synthesis model is determined based on the difference between the synthesized speech and the standard speech, and the model parameter of the speech synthesis model is updated based on the value of the loss function of the speech synthesis model, to train the speech synthesis model.

In some embodiments, after decoding the speech bit stream by using the speech decoding model, to obtain the synthesized speech corresponding to the text sample, the server may further determine the synthesized speech by using a second speech determining model, to obtain a second determining result, the second determining result being configured for indicating a degree of possibility that the synthesized speech is obtained through prediction by using the speech synthesis model. Correspondingly, the server may update the model parameter of the speech synthesis model based on the difference between the synthesized speech and the standard speech in the following manner: determining a value of a third loss function of the speech synthesis model based on the difference between the synthesized speech and the standard speech; determining a value of a fourth loss function of the speech synthesis model based on the second determining result; and updating the model parameter of the speech synthesis model based on the value of the third loss function and the value of the fourth loss function.

In this embodiment, the speech synthesis model may also be trained by using an idea of adversarial training. To be specific, after the standard speech bit stream is decoded by using the speech synthesis model to obtain the synthesized speech, the synthesized speech is determined by using the second speech determining model, to obtain the second determining result. The second speech determining model is configured to determine whether the synthesized speech is generated by using the speech synthesis model, in other words, to determine a degree of possibility (or probability) that the synthesized speech is generated by using the speech synthesis model.

The standard speech may be considered as real speech data, and the synthesized speech (generated by using the speech synthesis model) may be considered as “counterfeit” speech data. When the second speech determining model is increasingly unable to determine whether the synthesized speech is generated by using the speech synthesis model (that is, the degree of possibility that the synthesized speech is generated by using the speech synthesis model is increasingly low), it is considered that the synthesized speech is increasingly close to the standard speech. Therefore, the synthesized speech may be determined by using the second speech determining model, to determine the degree of possibility (namely, the second determining result) that the synthesized speech is generated by using the speech synthesis model, to implement the adversarial training for the speech synthesis model based on the second determining result. In actual application, the second determining result indicating that the degree of possibility that the synthesized speech is generated by using the speech synthesis model is increasingly lower, in turn indicates that a speech synthesis capability of the speech synthesis model is increasingly better.

Based on this, when updating the model parameter of the speech synthesis model based on the difference between the standard speech and the synthesized speech, the server may determine the value of the third loss function of the speech synthesis model based on the difference between the standard speech and the synthesized speech, and determine the value of the fourth loss function of the speech synthesis model based on the second determining result, to update the model parameter of the speech synthesis model based on the value of the third loss function and the value of the fourth loss function. For example, the model parameter of the speech synthesis model is updated based on a sum of the value of the third loss function and the value of the fourth loss function, to train the speech synthesis model.

In some embodiments, a plurality of second speech determining models exist, each second speech determining model has a corresponding scale, and the scale is a scale of a speech bit stream determinable by the second speech determining model. Correspondingly, the server may determine the synthesized speech by using the second speech determining model in the following way: performing pooling on the speech bit stream at each scale, to obtain an intermediate speech bit stream at each scale; and determining, for each second speech determining model, an intermediate speech bit stream at a scale of the second speech determining model by using the second speech determining model, to obtain the second determining result.

In actual application, the plurality of second speech determining models may exist, each second speech determining model has the corresponding scale, and the scale is the scale of the speech bit stream determinable by the second speech determining model. Based on this, pooling needs to be performed on the speech bit stream at each scale, to obtain the intermediate speech bit stream at each scale, so that for each second speech determining model, the intermediate speech bit stream at the scale of the second speech determining model is determined by using the second speech determining model, to obtain the second determining result. In this way, a plurality of second determining results are obtained. When the value of the fourth loss function of the speech synthesis model is determined based on the second determining results, an intermediate value of the fourth loss function may be calculated for each second determining result, and then intermediate values are summed up to obtain the value of the fourth loss function.

The foregoing embodiment of this application is applied. The speech synthesis model provided in this embodiment of this application includes the acoustic model and the speech decoding model. During training of the speech synthesis model, speech bit stream prediction is performed on the text sample by using the acoustic model, to be specific, the speech bit stream of the text is modeled by using the acoustic model to obtain the speech bit stream, and then the speech bit stream is decoded by using the speech decoding model to obtain the synthesized speech of the text sample, so that the model parameter of the speech synthesis model is updated based on the difference between the synthesized speech and the standard speech of the text sample, to train the speech synthesis model. In this way, compared with the related art in which a vocoder restores a synthesized speech from a Mel spectrum to perform model training, in this embodiment of this application, for a bit stream decoding process in which the speech bit stream of the text sample is decoded to obtain the synthesized speech of the text sample, calculation complexity is low (complexity of the speech decoding model is lower than that of the vocoder), thereby reducing complexity of data calculation and consumption of a device resource in a process of training the speech synthesis model. In this way, duration for training the speech synthesis model can be reduced, and efficiency of training the speech synthesis model and a utilization rate of the device resource can be improved.

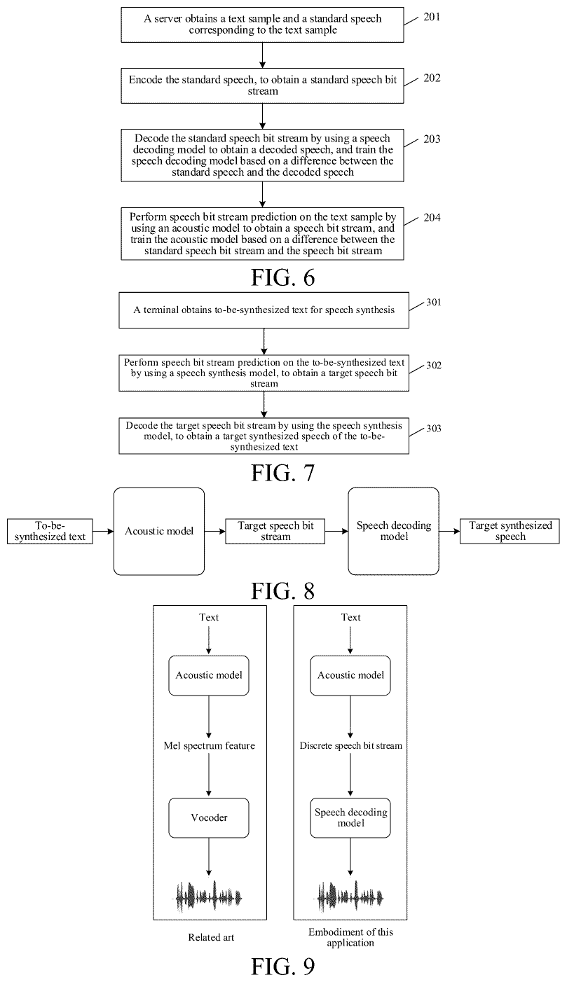

The following describes the method for training a speech synthesis model provided in the embodiments of this application. The speech synthesis model includes: a speech decoding model and an acoustic model. In some embodiments, the method for training a speech synthesis model provided in the embodiments of this application may be performed by various electronic devices, for example, may be performed by a terminal alone, may be performed by a server alone, or may be collaboratively performed by a terminal and a server. An example in which the method is performed by a server is used. FIG. 6 is a schematic flowchart of a method for training a speech synthesis model according to an embodiment of this application. The method for training a speech synthesis model according to this embodiment of this application includes the following operations.

Operation 201: A server obtains a text sample and a standard speech corresponding to the text sample.

In actual application, a user may trigger a model training instruction for the speech synthesis model at a terminal, thereby causing the terminal to transmit a model training request for the speech synthesis model to the server. If receiving the model training request transmitted by the terminal, the server trains the speech synthesis model in response to the model training request. In operation 201, when training the speech synthesis model, the server first obtains a text sample for training and a standard speech corresponding to the text sample. The standard speech is obtained by reading the text sample. For example, the text sample may include “hello”, “it is nice to meet you”, or the like.

Operation 202: Encode the standard speech, to obtain a standard speech bit stream.

In some embodiments, the standard speech includes a plurality of sampling points. The server may perform downsampling on each sampling point by using a plurality of cascaded downsampling layers, to obtain a standard speech variable of each sampling point; and quantize the standard speech variable of each sampling point, to obtain the standard speech bit stream.

In some other embodiments, the server may encode the standard speech by using a speech encoding model, to obtain the standard speech bit stream. The speech encoding model may be an encoder including a plurality of cascaded downsampling layers, and may be constructed based on a neural network (for example, a convolutional neural network or a deep neural network).

Operation 203: Decode the standard speech bit stream by using a speech decoding model, to obtain a decoded speech, and train the speech decoding model based on a difference between the standard speech and the decoded speech.

Operation 204: Perform speech bit stream prediction on the text sample by using an acoustic model, to obtain a speech bit stream, and train the acoustic model based on a difference between the standard speech bit stream and the speech bit stream.

The speech synthesis model is configured to perform speech bit stream prediction on target text based on the acoustic model to obtain a target speech bit stream, and decode the target speech bit stream based on the speech decoding model to obtain a synthesized speech of the target text.

In this embodiment of this application, the speech decoding model and the acoustic model are separately trained. To be specific: (1) The standard speech bit stream is decoded by using the speech decoding model to obtain the decoded speech, and a model parameter of the speech decoding model is updated based on the difference between the standard speech and the decoded speech, to train the speech decoding model. (2) Speech bit stream prediction is performed on the text sample by using the acoustic model to obtain the speech bit stream, and a model parameter of the acoustic model is updated based on the difference between the standard speech bit stream and the speech bit stream, to train the acoustic model. A process of training the speech decoding model is the same as a process of training the initial speech decoding model in the foregoing embodiment, and a process of training the acoustic model is the same as a process of training the initial acoustic decoding model in the foregoing embodiment.

The foregoing embodiment of this application is applied. The speech synthesis model provided in this embodiment of this application includes the acoustic model and the speech decoding model. When the speech synthesis model is trained, the standard speech of the text sample is first encoded, to obtain the standard speech bit stream. Then the standard speech bit stream is decoded by using the speech decoding model to obtain the decoded speech, so that the speech decoding model is trained based on the difference between the standard speech and the decoded speech. Speech bit stream prediction is further performed on the text sample by using the acoustic model to obtain the speech bit stream, so that the acoustic model is trained based on the difference between the standard speech bit stream and the speech bit stream. In this way, during speech synthesis, speech bit stream prediction may be performed on the target text based on the acoustic model, to obtain the target speech bit stream, and the target speech bit stream is decoded based on the speech decoding model, to obtain the synthesized speech of the target text.

(1) The speech bit stream is directly modeled for text by using the acoustic model to obtain a speech discrete feature of the text, so that an error between the speech bit stream and the standard speech bit stream obtained by encoding the standard speech is small. In turn, the synthesized speech obtained through decoding based on the speech bit stream is also accurate, and speech synthesis quality of the speech synthesis model is improved. (2) Compared with a vocoder in the related art, model complexity of the speech decoding model is low, and calculation complexity of a bit stream decoding process is low, thereby reducing overall complexity of the speech synthesis model, reducing duration for training the speech synthesis model, and improving efficiency of training the speech synthesis model. (3) Because an error of directly modeling the speech bit stream for the text is small, there may be no need to adjust the model parameter of the speech decoding model based on a predicted bit stream of the acoustic model, thereby reducing duration for training the speech synthesis model, and also improving efficiency of training the speech synthesis model.

The following describes the speech synthesis method provided in the embodiments of this application. The method is applied to a speech synthesis model, and the speech synthesis model includes: a speech decoding model and an acoustic model. In some embodiments, the speech synthesis method provided in the embodiments of this application may be performed by various electronic devices, for example, may be performed by a terminal alone, may be performed by a server alone, or may be collaboratively performed by a terminal and a server. An example in which the method is performed by a terminal is used. FIG. 7 is a schematic flowchart of a speech synthesis method according to an embodiment of this application. The speech synthesis method according to this embodiment of this application includes the following operations.

Operation 301: A terminal obtains to-be-synthesized text for speech synthesis.

Operation 302: Perform speech bit stream prediction on the to-be-synthesized text, to obtain a target speech bit stream.

Operation 303: Decode the target speech bit stream, to obtain a target synthesized speech of the to-be-synthesized text.

A speech synthesis model is obtained through training based on the method for training a speech synthesis model provided in the embodiments of this application.

In some embodiments, when speech synthesis is performed based on text, a speech synthesis instruction may be triggered at the terminal. In response to the speech synthesis instruction, the terminal may obtain a speech synthesis model for speech synthesis from a server. FIG. 8 is a schematic flowchart of speech synthesis according to an embodiment of this application. A speech synthesis model includes a speech decoding model and an acoustic model. During speech synthesis, a terminal obtains to-be-synthesized text for speech synthesis; performs speech bit stream prediction on the to-be-synthesized text by using the acoustic model of the speech synthesis model, to obtain a target speech bit stream; and decodes the target speech bit stream by using the speech decoding model of the speech synthesis model, to obtain a target synthesized speech of the to-be-synthesized text. In this way, the target synthesized speech synthesized based on the to-be-synthesized text is outputted.

The foregoing embodiment of this application is applied. During speech synthesis, speech bit stream prediction may be performed on the to-be-synthesized text based on the acoustic model, to obtain the target speech bit stream, and the target speech bit stream is decoded based on the speech decoding model, to obtain the target synthesized speech of the to-be-synthesized text. (1) The target speech bit stream is directly modeled for text by using the acoustic model to obtain a discrete speech feature of the text, so that an error between the predicted target speech bit stream and a speech bit stream obtained through encoding is small. In turn, the target synthesized speech obtained through decoding based on the target speech bit stream is also accurate, and speech synthesis quality of the speech synthesis model is improved. (2) Compared with a vocoder in the related art, model complexity of the speech decoding model is low, and calculation complexity of a bit stream decoding process is low, thereby reducing overall complexity of the speech synthesis model, reducing calculation duration of the speech synthesis model, and improving speech synthesis efficiency of the speech synthesis model.

The following describes exemplary application of this embodiment of this application in an actual application scenario.

In the related art, a speech synthesis model includes two parts: an acoustic model and a vocoder. The acoustic model is configured to model a Mel spectrum feature of a speech from text, and the vocoder is configured to restore a speech signal from a Mel spectrum. However, there are the following problems in the related art. (1) Because the Mel spectrum feature modeled by the acoustic model is lossy (with a large error) and irreversible, a vocoder with a complex parameter is generally required, to restore the speech signal from a Mel spectrum predicted by the acoustic model. As a result, complexity of the speech synthesis model is excessively high, and it takes a long time to train the speech synthesis model. (2) Complexity of the vocoder is excessively high. As a result, a speech synthesis service, when deployed on a server, can simultaneously support a limited quantity of synthesis channels, and a first packet delay of a synthesized speech is high. When the speech synthesis service is deployed on a mobile phone end, a parameter quantity of the vocoder generally needs to be greatly reduced, so that the service can be smoothly run on a mobile phone. However, when the parameter quantity of the vocoder is excessively small, sound quality of a speech generated through speech synthesis may significantly decrease. (3) Because the Mel spectrum is a high-dimensional continuous feature representation, and generally, there is a large error between the Mel spectrum predicted by the acoustic model and a Mel spectrum directly extracted from a speech. In this case, the parameter of the vocoder needs to be trained and adjusted by using the Mel spectrum predicted by the acoustic model, thereby further increasing duration for training the speech synthesis model.

Based on this, in this embodiment of this application, a solution in which a bit stream of an Al encoding and decoding model is used as a modeling target of the acoustic model, and a decoder for AI encoding and decoding is used as the vocoder is provided, thereby greatly reducing model complexity of the speech synthesis model, and greatly reducing time required for training the speech synthesis model. In addition, real-time performance of the speech synthesis service and a quantity of concurrent connections of the server can also be improved. The method for training a speech synthesis model provided in the embodiments of this application is described below in detail.

Operation 1: Training of a speech encoding model and a speech decoding model.

A Mel spectrum feature used in the related art is directly extracted from a speech signal by using Fourier transform and a Mel filter bank, and is an irreversible and lossy continuous feature representation. However, in the embodiments of this application, to extract a discrete feature representation from a speech, the speech encoding model and the speech decoding model are first trained, to encode the speech and decode and restore the speech.

As shown in FIG. 5: (1) For a standard speech of a text sample, the standard speech is encoded by using the speech encoding model, to obtain a standard speech bit stream.

In actual application, first, the standard speech (namely, the speech signal) x is downsampled and encoded into a continuous hidden layer variable h by using the speech encoding model:

h=f(x),

where f represents an overall calculation function of the speech encoding model. A speech sampled at 16 kHz is used as an example, and a speech signal x of 1 second includes 16,000 sampling points. When a length of a continuous variable h obtained after downsampling is performed for 320 times for f is changed to 50, a dimension may be set to 80.

Then, after the continuous hidden layer variable h is obtained, the hidden layer variable h is quantized by using a quantizer, to convert a continuous feature representation (namely, the hidden layer variable h) into a discrete feature representation h′. A matrix size of the discrete feature representation h′ is consistent with that of h, but a value range of h′ is changed from an infinite space to a finite space. In this way, a standard speech bit stream h′ corresponding to the text sample is obtained.

(2) The standard speech bit stream is decoded by using the speech decoding model, to obtain a decoded speech. To be specific, based on the discrete feature representation h′, the speech decoding model obtains a decoded speech x′ from h′ by using a plurality of upsampling layers:

x′=g(h′)

where g represents an overall calculation function of the speech decoding model, and a parameter quantity of the speech decoding model is much less than a parameter quantity of a vocoder in Mel spectrum-based speech synthesis.

(3) The speech decoding model is trained based on a difference between the standard speech and the decoded speech. To be specific, during training, an error between the decoded speech x′ and the standard speech x is optimized, and adversarial training is performed by using a plurality of speech determining models, thereby ensuring sound quality of a restored speech. A loss function [symbol] of the speech encoding model is as follows (which is the same as that of the speech decoding model):

$$ℒ = {ℒ}_{𝓍} + {ℒ}_{adv} \\ {ℒ}_{𝓍} = \vert x - {x}^{′} \vert \\ {ℒ}_{adv} = {\sum }_{k = 1}^{K} ( {{D}_{k} ( G ( x ) - 1 )}^{2} )$$

where Dₖ represents a k^{th} speech determining model, and G(x) is a determining result of the speech determining model.

Based on this, the training of the speech encoding model and the speech decoding model is completed. The speech encoding model and the speech decoding model are a general speech codec. After the training is completed, a discrete standard speech bit stream h′ may be extracted, by using the speech encoding model, from a standard speech of a text sample required for training the speech synthesis model, to be used as a modeling target of an acoustic model in the speech synthesis model, and the speech decoding model directly replaces a vocoder of the speech synthesis model for speech synthesis.

Operation 2: Speech bit stream prediction is performed on the text sample by using the acoustic model, to obtain a speech bit stream, and the acoustic model is trained based on a difference between the standard speech bit stream and the speech bit stream.

Any existing acoustic model architecture may be used for a structure of the acoustic model. Speech bit stream prediction is performed on the text sample by using the acoustic model to obtain a speech bit stream m(t), so that training is performed based on a difference between the speech bit stream m(t) and the standard speech bit stream h′. A loss function of the acoustic model is as follows:

$$ℒ = \vert {h}^{′} - m ( t ) \vert$$

where h′ is the standard speech bit stream, a function m represents a calculation procedure of the acoustic model, and t represents an inputted text sample.

After the speech bit stream is obtained through prediction by using the acoustic model, because the speech bit stream is a discrete feature representation, a fine prediction error brought by the acoustic model can be ignored. Therefore, even if a parameter of the speech decoding model is not adjusted again, a synthesized speech with good quality can be obtained. Certainly, to improve sound quality of the synthesized speech, the parameter of the speech decoding model may be adjusted by using the speech bit stream obtained through prediction by using the acoustic model. Due to robustness of the speech decoding model, a high-quality speech decoding model can be obtained in short time, to replace the vocoder in the speech synthesis model, reduce complexity of the speech synthesis model, and improve efficiency of training the speech synthesis model.

FIG. 9 is a schematic diagram of comparison between a speech synthesis method according to the related art and a speech synthesis method according to an embodiment of this application. As indicated in FIG. 9, a processing procedure of a speech synthesis model in the related art is: predicting a Mel spectrum feature of a speech from text by using an acoustic model, and obtaining a synthesized speech of the text based on the Mel spectrum feature by using a vocoder. A processing procedure of a speech synthesis model provided in this embodiment of this application is: predicting a speech bit stream of a speech from text by using an acoustic model, and decoding the speech bit stream by using a speech decoding model, to obtain a synthesized speech of the text.

The foregoing embodiment of this application is applied. (1) The acoustic model is enabled to directly model a discrete feature representation (namely, the speech bit stream) of the speech, and an original complex vocoder is replaced by using a decoder. An experimental result shows that, in this embodiment of this application, only a decoder model with a parameter quantity of 0.5 M is required to achieve speech quality of a vocoder with an original parameter quantity of 4 M, and a real-time rate of the vocoder is reduced from 0.18 to 0.016. This greatly improves synthesis efficiency of the speech synthesis model, so that the speech synthesis model can be easily deployed to a mobile terminal device without damaging and sacrificing sound quality. (2) Because duration for training the speech decoding model is very short, deployment time of a new timbre in the speech synthesis model is greatly shortened. (3) Calculation complexity of the speech decoding model is low, and calculation efficiency of the speech decoding model is improved by 10 times compared with that of the conventional vocoder. This can greatly reduce a first packet delay and a load on a server.

In the embodiments of this application, related data such as user information is involved. When the embodiments of this application are applied to a specific product or technology, user permission or consent is required to be obtained, and relevant collection, use, and processing of data are required to comply with relevant laws, regulations, and standards of relevant countries and regions.

The following continues to describe an exemplary structure of an apparatus 553 for training a speech synthesis model and implemented as a software module according to an embodiment of this application. In some embodiments, as shown in FIG. 2, the software module in the apparatus 553 for training a speech synthesis model and stored in the memory 550 may include: a first obtaining module 5531, configured to obtain a text sample and a standard speech corresponding to the text sample; a prediction module 5532, configured to perform speech bit stream prediction on the text sample by using the speech synthesis model, to obtain a speech bit stream corresponding to the text sample; a decoding module 5533, configured to decode the speech bit stream by using the speech synthesis model, to obtain a synthesized speech corresponding to the text sample; and an update module 5534, configured to update a model parameter of the speech synthesis model based on a difference between the synthesized speech and the standard speech, to train the speech synthesis model, the speech synthesis model being configured to perform speech bit stream prediction on target text to obtain a target speech bit stream, and decode the target speech bit stream to obtain a synthesized speech of the target text.

In some embodiments, the prediction module 5532 is further configured to: perform word segmentation on the text sample to obtain a plurality of word segments, and perform feature extraction on each word segment to obtain a word segment feature of each word segment; obtain a phoneme of each piece of text in the text sample, and perform pronunciation duration prediction on each phoneme, to obtain pronunciation duration of each phoneme; perform, for each word segment, speech bit stream prediction on the word segment based on pronunciation duration of a phoneme of text included in the word segment and the word segment feature of the word segment, to obtain a word segment bit stream of the word segment; and splice word segment bit streams of the plurality of word segments, to obtain the speech bit stream corresponding to the text sample.

In some embodiments, the prediction module 5532 is further configured to perform speech bit stream prediction on the text sample by using an acoustic model of the speech synthesis model, to obtain the speech bit stream corresponding to the text sample; and the decoding module 5533 is further configured to decode the speech bit stream by using a speech decoding model of the speech synthesis model, to obtain the synthesized speech corresponding to the text sample.

In some embodiments, the speech decoding model includes a plurality of cascaded upsampling layers, and the decoding module 5533 is further configured to perform upsampling on the speech bit stream by using the plurality of cascaded upsampling layers, to obtain the synthesized speech corresponding to the text sample.

In some embodiments, the update module 5534 is further configured to: encode the standard speech, to obtain a standard speech bit stream; perform speech bit stream prediction on the text sample by using an initial acoustic model, to obtain a target speech bit stream; update a model parameter of the initial acoustic model based on a difference between the standard speech bit stream and the target speech bit stream, to train the initial acoustic model; and determine a trained initial acoustic model as the acoustic model.

In some embodiments, the update module 5534 is further configured to: encode the standard speech, to obtain a standard speech bit stream; decode the standard speech bit stream by using an initial speech decoding model, to obtain a decoded speech; update a model parameter of the initial speech decoding model based on a difference between the standard speech and the decoded speech, to train the initial speech decoding model; and determine a trained initial speech decoding model as the speech decoding model.

In some embodiments, the update module 5534 is further configured to determine the decoded speech by using a first speech determining model, to obtain a first determining result, the first determining result being configured for indicating a degree of possibility that the decoded speech is obtained through decoding by using the initial speech decoding model; and the update module 5534 is further configured to: determine a value of a first loss function of the initial speech decoding model based on the difference between the standard speech and the decoded speech, and determine a value of a second loss function of the initial speech decoding model based on the first determining result; and update the model parameter of the initial speech decoding model based on the value of the first loss function and the value of the second loss function.

In some embodiments, the update module 5534 is further configured to encode the standard speech by using a speech encoding model, to obtain the standard speech bit stream; and the update module 5534 is further configured to update a model parameter of the speech encoding model based on the difference between the standard speech and the decoded speech, to train the speech encoding model.

In some embodiments, the standard speech includes a plurality of sampling points, and the update module 5534 is further configured to: perform downsampling on each sampling point by using a plurality of cascaded downsampling layers, to obtain a standard speech variable of each sampling point; and quantize the standard speech variable of each sampling point, to obtain the standard speech bit stream.

In some embodiments, the update module 5534 is further configured to determine the synthesized speech by using a second speech determining model, to obtain a second determining result, the second determining result being configured for indicating a degree of possibility that the synthesized speech is obtained through prediction by using the speech synthesis model; and the update module 5534 is further configured to: determine a value of a third loss function of the speech synthesis model based on the difference between the synthesized speech and the standard speech; determine a value of a fourth loss function of the speech synthesis model based on the second determining result; and update the model parameter of the speech synthesis model based on the value of the third loss function and the value of the fourth loss function.

In some embodiments, a plurality of second speech determining models exist, each second speech determining model has a corresponding scale, and the scale is a scale of a speech bit stream determinable by the second speech determining model; and the update module 5534 is further configured to: perform pooling on the speech bit stream at each scale, to obtain an intermediate speech bit stream at each scale; and determine, for each second speech determining model, an intermediate speech bit stream at a scale of the second speech determining model by using the second speech determining model, to obtain the second determining result.

The foregoing embodiment of this application is applied. The speech synthesis model provided in this embodiment of this application includes the acoustic model and the speech decoding model. During training of the speech synthesis model, speech bit stream prediction is performed on the text sample by using the acoustic model, to be specific, the speech bit stream of the text is modeled by using the acoustic model to obtain the speech bit stream, and then the speech bit stream is decoded by using the speech decoding model to obtain the synthesized speech of the text sample, so that the model parameter of the speech synthesis model is updated based on the difference between the synthesized speech and the standard speech of the text sample, to train the speech synthesis model. In this way, compared with a vocoder in the related art, model complexity of the speech decoding model is low, and calculation complexity of a bit stream decoding process is low, thereby reducing overall complexity of the speech synthesis model, reducing duration for training the speech synthesis model, and improving efficiency of training the speech synthesis model.

The following continues to describe the apparatus for training a speech synthesis model provided in the embodiments of this application. The speech synthesis model includes: a speech decoding model and an acoustic model. The apparatus includes: a second obtaining module, configured to obtain a text sample and a standard speech corresponding to the text sample; an encoding module, configured to encode the standard speech, to obtain a standard speech bit stream; a first training module, configured to decode the standard speech bit stream by using the speech decoding model to obtain a decoded speech, and train the speech decoding model based on a difference between the standard speech and the decoded speech; and a second training module, configured to perform speech bit stream prediction on the text sample by using the acoustic model to obtain a speech bit stream, and train the acoustic model based on a difference between the standard speech bit stream and the speech bit stream, the speech synthesis model being configured to perform speech bit stream prediction on target text based on the acoustic model to obtain a target speech bit stream, and decode the target speech bit stream based on the speech decoding model to obtain a synthesized speech of the target text.

The foregoing embodiment of this application is applied. The speech synthesis model provided in this embodiment of this application includes the acoustic model and the speech decoding model. When the speech synthesis model is trained, the standard speech of the text sample is first encoded, to obtain the standard speech bit stream. Then, the standard speech bit stream is decoded by using the speech decoding model to obtain the decoded speech, so that the speech decoding model is trained based on the difference between the standard speech and the decoded speech. Speech bit stream prediction is further performed on the text sample by using the acoustic model to obtain the speech bit stream, so that the acoustic model is trained based on the difference between the standard speech bit stream and the speech bit stream. In this way, during speech synthesis, speech bit stream prediction may be performed on the target text based on the acoustic model, to obtain the target speech bit stream, and the target speech bit stream is decoded based on the speech decoding model, to obtain the synthesized speech of the target text.

(1) The speech bit stream is directly modeled for text by using the acoustic model to obtain a speech discrete feature of the text, so that an error between the speech bit stream and the standard speech bit stream obtained by encoding the standard speech is small. In turn, the synthesized speech obtained through decoding based on the speech bit stream is also accurate, and speech synthesis quality of the speech synthesis model is improved. (2) Compared with a vocoder in the related art, model complexity of the speech decoding model is low, and calculation complexity of a bit stream decoding process is low, thereby reducing overall complexity of the speech synthesis model, reducing duration for training the speech synthesis model, and improving efficiency of training the speech synthesis model. (3) Because an error of directly modeling the speech bit stream for the text is small, there may be no need to adjust the model parameter of the speech decoding model based on a predicted bit stream of the acoustic model, thereby reducing duration for training the speech synthesis model, and also improving efficiency of training the speech synthesis model.

The following continues to describe a speech synthesis apparatus according to an embodiment of this application. The apparatus is applied to a speech synthesis model, and the apparatus includes: a third obtaining module, configured to obtain to-be-synthesized text for speech synthesis; a bit stream prediction module, configured to perform speech bit stream prediction on the to-be-synthesized text by using the speech synthesis model, to obtain a target speech bit stream; and a bit stream decoding module, configured to decode the target speech bit stream by using the speech synthesis model, to obtain a target synthesized speech of the to-be-synthesized text, the speech synthesis model being obtained through training based on the method for training a speech synthesis model provided in the embodiments of this application.

The foregoing embodiment of this application is applied. During speech synthesis, speech bit stream prediction may be performed on the to-be-synthesized text based on the acoustic model, to obtain the target speech bit stream, and the target speech bit stream is decoded based on the speech decoding model, to obtain the target synthesized speech of the to-be-synthesized text. (1) The target speech bit stream is directly modeled for text by using the acoustic model to obtain a discrete speech feature of the text, so that an error between the predicted target speech bit stream and a speech bit stream obtained through encoding is small. In turn, the target synthesized speech obtained through decoding based on the target speech bit stream is also accurate, and speech synthesis quality of the speech synthesis model is improved. (2) Compared with a vocoder in the related art, model complexity of the speech decoding model is low, and calculation complexity of a bit stream decoding process is low, thereby reducing overall complexity of the speech synthesis model, reducing calculation duration of the speech synthesis model, and improving speech synthesis efficiency of the speech synthesis model.

An embodiment of this application further provides a computer program product, the computer program product including a computer program or computer-executable instructions, the computer program or the computer instructions being stored in a computer-readable storage medium. A processor of an electronic device reads the computer instructions from the computer-readable storage medium, and executes the computer instructions, to cause the electronic device to perform the method provided in the embodiments of this application.

An embodiment of this application further provides a computer-readable storage medium, having computer-executable instructions stored therein, the computer-executable instructions, when executed by a processor, causing the processor to perform the method provided in the embodiments of this application.

In some embodiments, the computer-readable storage medium may be a memory such as a read-only memory (ROM), a random access memory (RAM), an erasable programmable read-only memory (EPROM), an electrically erasable programmable read-only memory (EEPROM), a flash memory, a magnetic surface memory, an optic disc, or a CD-ROM, or may be any device including one of or any combination of the foregoing memories.

In some embodiments, the computer-executable instructions may be written in any form of programming language (including a compiled or interpreted language, or a declarative or procedural language) by using the form of a program, software, a software module, a script or code, and may be deployed in any form, including being deployed as an independent program or being deployed as a module, a component, a subroutine, or another unit suitable for use in a computing environment.

In an example, the computer-executable instructions may, but do not necessarily, correspond to a file in a file system, and may be stored in a part of a file that saves another program or other data, for example, be stored in one or more scripts in a hypertext markup language (HTML) file, stored in a file that is specially configured for a program in discussion, or stored in the plurality of collaborative files (for example, be stored in files of one or modules, subprograms, or code parts).

In an example, the computer-executable instructions may be deployed to be executed on an electronic device, or deployed to be executed on a plurality of electronic devices at the same location, or deployed to be executed on a plurality of electronic devices that are distributed in a plurality of locations and interconnected by using a communication network.

The foregoing descriptions are merely embodiments of this application and are not intended to limit the protection scope of this application. Any modification, equivalent replacement, or improvement made without departing from the spirit and range of this application shall fall within the protection scope of this application.

What is claimed is:

1. A method for training a speech synthesis model, performed by an electronic device, the method comprising:
obtaining a text sample and a standard speech corresponding to the text sample;
performing speech bit stream prediction on the text sample by using the speech synthesis model, to obtain a speech bit stream corresponding to the text sample;
decoding the speech bit stream by using the speech synthesis model, to obtain a synthesized speech corresponding to the text sample; and
updating a model parameter of the speech synthesis model based on a difference between the synthesized speech and the standard speech, the speech synthesis model being configured to output, based on inputted target text, a synthesized speech of the target text.

2. The method according to claim 1, wherein the performing speech bit stream prediction on the text sample, to obtain a speech bit stream corresponding to the text sample comprises:
performing word segmentation on the text sample to obtain a plurality of word segments, and performing feature extraction on each word segment to obtain a word segment feature of each word segment;
obtaining a phoneme of each piece of text in the text sample, and performing pronunciation duration prediction on each phoneme, to obtain pronunciation duration of each phoneme;
performing, for each word segment, speech bit stream prediction on the word segment based on pronunciation duration of a phoneme of text comprised in the word segment and the word segment feature of the word segment, to obtain a word segment bit stream of the word segment; and
splicing word segment bit streams of the plurality of word segments, to obtain the speech bit stream corresponding to the text sample.

3. The method according to claim 1, wherein the performing speech bit stream prediction on the text sample by using the speech synthesis model, to obtain a speech bit stream corresponding to the text sample comprises:
performing speech bit stream prediction on the text sample by using an acoustic model in the speech synthesis model, to obtain the speech bit stream corresponding to the text sample, and
wherein the decoding the speech bit stream by using the speech synthesis model, to obtain a synthesized speech corresponding to the text sample comprises:
decoding the speech bit stream by using a speech decoding model in the speech synthesis model, to obtain the synthesized speech corresponding to the text sample.

4. The method according to claim 3, wherein the speech decoding model comprises a plurality of cascaded upsampling layers, and the decoding the speech bit stream by using a speech decoding model in the speech synthesis model, to obtain the synthesized speech corresponding to the text sample comprises:
performing upsampling on the speech bit stream by using the plurality of cascaded upsampling layers, to obtain the synthesized speech corresponding to the text sample.

5. The method according to claim 3, wherein before the performing speech bit stream prediction on the text sample by using the speech synthesis model, to obtain a speech bit stream corresponding to the text sample, the method further comprises:
encoding the standard speech, to obtain a standard speech bit stream;
performing speech bit stream prediction on the text sample by using an initial acoustic model, to obtain a target speech bit stream; and
updating a model parameter of the initial acoustic model based on a difference between the standard speech bit stream and the target speech bit stream, and determining an updated initial acoustic model as the acoustic model.

6. The method according to claim 3, wherein before the decoding the speech bit stream by using the speech synthesis model, to obtain a synthesized speech corresponding to the text sample, the method further comprises:
encoding the standard speech, to obtain a standard speech bit stream;
decoding the standard speech bit stream by using an initial speech decoding model, to obtain a decoded speech; and
updating a model parameter of the initial speech decoding model based on a difference between the standard speech and the decoded speech, and determining an updated initial speech decoding model as the speech decoding model.

7. The method according to claim 6, wherein after the decoding the standard speech bit stream by using an initial speech decoding model, to obtain a decoded speech, the method further comprises:
determining the decoded speech by using a first speech determining model, to obtain a first determining result, the first determining result being configured for indicating a degree of possibility that the decoded speech is obtained through decoding by using the initial speech decoding model, and
wherein the updating a model parameter of the initial speech decoding model based on a difference between the standard speech and the decoded speech comprises:
determining a value of a first loss function of the initial speech decoding model based on the difference between the standard speech and the decoded speech;
determining a value of a second loss function of the initial speech decoding model based on the first determining result; and
updating the model parameter of the initial speech decoding model based on the value of the first loss function and the value of the second loss function.

8. The method according to claim 6, wherein the encoding the standard speech, to obtain a standard speech bit stream comprises:
encoding the standard speech by using a speech encoding model, to obtain the standard speech bit stream; and
the method further comprises:
updating a model parameter of the speech encoding model based on the difference between the standard speech and the decoded speech.

9. The method according to claim 5, wherein the standard speech comprises a plurality of sampling points, and the encoding the standard speech, to obtain a standard speech bit stream comprises:
performing downsampling on each sampling point by using a plurality of cascaded downsampling layers, to obtain a standard speech variable of each sampling point; and
quantizing the standard speech variable of each sampling point, to obtain the standard speech bit stream.

10. The method according to claim 1, wherein after the decoding the speech bit stream by using the speech synthesis model, to obtain a synthesized speech corresponding to the text sample, the method further comprises:
determining the synthesized speech by using a second speech determining model, to obtain a second determining result,
the second determining result being configured to indicate a degree of possibility that the synthesized speech is obtained through prediction by using the speech synthesis model; and
the updating a model parameter of the speech synthesis model based on a difference between the synthesized speech and the standard speech comprises:
determining a value of a third loss function of the speech synthesis model based on the difference between the synthesized speech and the standard speech;
determining a value of a fourth loss function of the speech synthesis model based on the second determining result; and
updating the model parameter of the speech synthesis model based on the value of the third loss function and the value of the fourth loss function.

11. The method according to claim 10, wherein for a plurality of second speech determining models, each second speech determining model has a corresponding scale of a speech bit stream determinable by the second speech determining model, and
wherein the determining the synthesized speech by using a second speech determining model, to obtain a second determining result comprises:
performing pooling on the speech bit stream at each scale, to obtain an intermediate speech bit stream at each scale; and
determining, for each second speech determining model of the plurality of second speech determining models, an intermediate speech bit stream at a scale of the second speech determining model by using the second speech determining model, to obtain the second determining result.

12. An apparatus for training a speech synthesis model, comprising:
a memory storing a plurality of computer-executable instructions; and
a processor configured to execute the plurality of computer-executable instructions, wherein upon execution of the plurality of computer-executable instructions, the processor is configured to:
obtain a text sample and a standard speech corresponding to the text sample;
perform speech bit stream prediction on the text sample by using the speech synthesis model, to obtain a speech bit stream corresponding to the text sample;
decode the speech bit stream by using the speech synthesis model, to obtain a synthesized speech corresponding to the text sample; and
update a model parameter of the speech synthesis model based on a difference between the synthesized speech and the standard speech, the speech synthesis model being configured to output, based on inputted target text, a synthesized speech of the target text.

13. The apparatus according to claim 12, wherein in order to performing speech bit stream prediction on the text sample, to obtain the speech bit stream corresponding to the text sample, the processor, upon execution of the plurality of computer-executable instructions, is configured to:
perform word segmentation on the text sample to obtain a plurality of word segments, and perform feature extraction on each word segment to obtain a word segment feature of each word segment;
obtain a phoneme of each piece of text in the text sample, and perform pronunciation duration prediction on each phoneme, to obtain pronunciation duration of each phoneme;
perform, for each word segment, speech bit stream prediction on the word segment based on pronunciation duration of a phoneme of text comprised in the word segment and the word segment feature of the word segment, to obtain a word segment bit stream of the word segment; and
splice word segment bit streams of the plurality of word segments, to obtain the speech bit stream corresponding to the text sample.

14. The apparatus according to claim 12, wherein in order to perform speech bit stream prediction on the text sample by using the speech synthesis model, to obtain the speech bit stream corresponding to the text sample, the processor, upon execution of the plurality of computer-executable instructions, is configured to:
perform speech bit stream prediction on the text sample by using an acoustic model in the speech synthesis model, to obtain the speech bit stream corresponding to the text sample, and
wherein in order to decode the speech bit stream by using the speech synthesis model, to obtain a synthesized speech corresponding to the text sample, the processor, upon execution of the plurality of computer-executable instructions, is configured to:
decode the speech bit stream by using a speech decoding model in the speech synthesis model, to obtain the synthesized speech corresponding to the text sample.

15. The apparatus according to claim 14, wherein the speech decoding model comprises a plurality of cascaded upsampling layers, and in order to decode the speech bit stream by using a speech decoding model in the speech synthesis model, to obtain the synthesized speech corresponding to the text sample, the processor, upon execution of the plurality of computer-executable instructions, is configured to:
perform upsampling on the speech bit stream by using the plurality of cascaded upsampling layers, to obtain the synthesized speech corresponding to the text sample.

16. The apparatus according to claim 14, wherein before performance of the speech bit stream prediction on the text sample by using the speech synthesis model, to obtain a speech bit stream corresponding to the text sample, the processor, upon execution of the plurality of computer-executable instructions, is further configured to:
encode the standard speech, to obtain a standard speech bit stream;
perform speech bit stream prediction on the text sample by using an initial acoustic model, to obtain a target speech bit stream; and
update a model parameter of the initial acoustic model based on a difference between the standard speech bit stream and the target speech bit stream, and determine an updated initial acoustic model as the acoustic model.

17. A non-transitory computer-readable storage medium storing a plurality of computer-executable instructions, wherein when executed by a processor, the plurality of computer-executable instructions cause the processor to:
obtain a text sample and a standard speech corresponding to the text sample;
perform speech bit stream prediction on the text sample by using the speech synthesis model, to obtain a speech bit stream corresponding to the text sample;
decode the speech bit stream by using the speech synthesis model, to obtain a synthesized speech corresponding to the text sample; and
update a model parameter of the speech synthesis model based on a difference between the synthesized speech and the standard speech, the speech synthesis model being configured to output, based on inputted target text, a synthesized speech of the target text.

18. The non-transitory computer-readable storage medium according to claim 17, wherein in order for the processor to perform speech bit stream prediction on the text sample by using the speech synthesis model, to obtain the speech bit stream corresponding to the text sample, the plurality of computer-executable instructions, when executed by the processor, is configured to cause the processor to:
perform speech bit stream prediction on the text sample by using an acoustic model in the speech synthesis model, to obtain the speech bit stream corresponding to the text sample, and
wherein in order for the processor to decode the speech bit stream by using the speech synthesis model, to obtain a synthesized speech corresponding to the text sample, the plurality of computer-executable instructions, when executed by the processor, is configured to cause the processor to:
decode the speech bit stream by using a speech decoding model in the speech synthesis model, to obtain the synthesized speech corresponding to the text sample.

19. The non-transitory computer-readable storage medium according to claim 18, wherein before the decoding of the speech bit stream by using the speech synthesis model, to obtain a synthesized speech corresponding to the text sample, the plurality of computer-executable instructions, when executed by the processor, cause the processor to:
encode the standard speech, to obtain a standard speech bit stream;
decode the standard speech bit stream by using an initial speech decoding model, to obtain a decoded speech; and
update a model parameter of the initial speech decoding model based on a difference between the standard speech and the decoded speech, and determine an updated initial speech decoding model as the speech decoding model.

20. The non-transitory computer-readable storage medium according to claim 17, wherein after the decoding of the speech bit stream by using the speech synthesis model, to obtain a synthesized speech corresponding to the text sample, the plurality of computer-executable instructions, when executed by the processor, further cause the processor to:
determine the synthesized speech by using a second speech determining model, to obtain a second determining result,
the second determining result being configured to indicate a degree of possibility that the synthesized speech is obtained through prediction by using the speech synthesis model; and
in order for the processor to update the model parameter of the speech synthesis model based on the difference between the synthesized speech and the standard speech, the plurality of computer-executable instructions, when executed by the processor, is configured to cause the processor to:
determine a value of a third loss function of the speech synthesis model based on the difference between the synthesized speech and the standard speech;
determine a value of a fourth loss function of the speech synthesis model based on the second determining result; and
update the model parameter of the speech synthesis model based on the value of the third loss function and the value of the fourth loss function.
